(19) United States
(12) Patent Application Publication
(10) Pub. No.: US 2014/0328669 A1
(43) Pub. Date: Nov. 6, 2014

(54) AIRFOIL WITH COOLING PASSAGES

(71) Applicants: Vitaly Bregman, Moscow (RU); Alexander Semenov, Korolev Moscow region (RU); Esa Utriainen, Svartinge (SE)

(72) Inventors: Vitaly Bregman, Moscow (RU); Alexander Semenov, Korolev Moscow region (RU); Esa Utriainen, Svartinge (SE)

(73) Assignee: SIEMENS AKTIENGESELLSCHAFT, Munich (DE)

(21) Appl. No.: 14/359,426

(22) PCT Filed: Nov. 25, 2011
(86) PCT No.: PCT/RU2011/000928

§ 371 Date: Jul. 28, 2014

(51) Int. Cl. F01D 5/18

(52) U.S. Cl. CPC F01D 5/186; F05D 2260/201; F05D 2260/202
USPC 415/115

(57) ABSTRACT

An airfoil having cooling passages inside is provided, wherein each radial cross section of the airfoil has a shape of specific profile, wherein hot gas flows along the airfoil's surface from a leading edge to trailing edge, the airfoil's surface comprises a pressure-side and suction-side defined by the trailing edge and leading edge, wherein the trailing edge has cooling fluid discharge exits, the pressure-side and suction-side are respectively defined by a wall comprising an inner surface and an outer surface, which inner surface has ribs extending in a rib-direction inclined to the radial direction, wherein along a portion of at least 10% of the profile's lengths the inclined ribs contact each other at respective cross-contact-points, forming a 2-dimensional matrix. At least one additional blocking-rib extends from the pressure-side to the suction-side and extends from one cross-contact-point to another to cause additional turbulence of said cooling fluid flow to be discharged.

### CROSS REFERENCE TO RELATED APPLICATIONS

This application is the US National Stage of International Application No. PCT/RU2011/000928 filed Nov. 25, 2011, and claims the benefit thereof, and is incorporated by reference herein in its entirety.

### FIELD OF INVENTION

The invention relates to an airfoil of a blade or a vane for a turbo machine, especially a gas turbine, wherein cooling passages are provided inside said airfoil, wherein said airfoil extends in a radial direction from a first end to a second end, wherein a cooling fluid inlet is provided at said first end or said second end, wherein each radial cross section of said airfoil has a shape of a specific profile, wherein said airfoil is made to be exposed to a hot gas flowing along said airfoil's surface from a leading edge to a trailing edge of said profile, wherein said airfoil's surface comprises a pressure-side and a suction-side which are defined from each other by said trailing edge and said leading edge, wherein said trailing edge is provided with cooling fluid discharge exits, wherein said pressure-side and said suction-side are respectively defined by a wall comprising an inner surface and an outer surface, which inner surface is provided with ribs extending in a rib-direction inclined to said radial direction, wherein along a portion of at least 10% of said profile's lengths said inclined ribs of said inner surface of said pressure-side and said suction-side contact each other at respective cross-contact-points, wherein said cross-contact-points form a 2-dimensional matrix.

### BACKGROUND OF INVENTION

Modern gas turbines operate at combustion temperatures of approximately 1300° C. which thermal impact makes it currently nearly impossible for any material to be suitable for the mechanical stress of operation and to be suitable to fulfill lifetime requirements without additional measures to extend lifetime. This technical task becomes most challenging in the case of a first stage gas turbine blade and a first stage gas turbine vane. The trailing edge of a gas turbine vane airfoil or a rotor blade airfoil is a region that is very difficult to cool effectively for several reasons.

The impact on the airfoil's outer surface is comparatively high since the external flow heat transfer rate is high due to high aero flow velocities. The trailing edge itself is thin which gives little room for geometric features that would enhance cooling. The cooling air temperature is usually elevated as the cooling air already did pick up a lot of heat from cooling other parts of the airfoil prior to entering the trailing edge region. Furthermore it is crucial to the efficiency of the gas turbine to find an effective trailing edge cooling concept which helps to reduce the amount of coolant spent for the component. The so called secondary air consumption has a significant impact on the efficiency of a gas turbine since the secondary air mixing with the hot gas from the combustor cools down the hot gas temperature and therefore reduces the Carnot-efficiency as well as the overall thermal efficiency of this Brayton cycle.

Advanced known trailing edge cooling concepts are disclosed in EP 1 082 523 B 1, EP 1 925 780 A1, U.S. Pat. No. 7,674,092 B2, WO 2005083235 A1 and WO 2005083236 A1. This patent application assumes the EP 1 082 523 B1 to be the closest prior art and also deems it's content for a person with ordinary skill in the art to be incorporated.

### SUMMARY OF INVENTION

Considering the problems and challenges of the prior art it is one object of the invention to improve the cooling concept efficiency of a gas turbine's blade or vane airfoil. The invention especially focuses on the trailing edge of said airfoil. It is a further object to improve the thermal efficiency of a gas turbine by reducing the secondary air consumption.

The above objects are achieved by an incipiently mentioned type of an airfoil with at least one additional blocking-rib being provided extending from the pressure-side to the suction-side and extending from one cross-contact-point to another cross-contact-point to cause additional turbulence of the cooling fluid flow to be discharged. This cooling concept improves the cooling effectiveness due to two main principles. In a first instance said blocking-ribs of the trailing edge passage protrude into the flow passage to increase the wall area surface by which convective heat exchange occurs. The second effect is that these geometric features enhance flow turbulence and direct the flow in a way that the flow will impinge on the passage walls creating further improved heat transfer. In other words, both the turbulence and the flow impingement will disturb the near wall flow boundary layers in a way that will increase the heat transfer coefficients to the walls.

A preferred embodiment provides said blocking-ribs extending from one cross-contact-point to an adjacent cross-contact-point. Preferably the adjacent cross-contact-point which is incorporated by the blocking-rib is one of the nearest cross-contact-points relative to the other cross-contact-point being incorporated by the blocking-rib.

Another preferred embodiment of the invention provides the blocking-rib extending along a rib direction which is directed in the same inclination angle as said ribs on the inner surface of the pressure-side wall or said suction-side wall.

Another possibility is an extension of the blocking-ribs along a direction perpendicular to the inclination of said ribs' direction.

Another preferred embodiment provides said blocking-ribs extending in said radial direction to effectively cause turbulence of the coolant.

Another preferred embodiment of the invention provides said blocking-ribs extending perpendicular to said radial direction. This seems to be especially efficient since the cooling fluid respectively coolant is ejected basically in the same direction respectively perpendicular to the radial direction. Another possibility which causes the desired heat transfer enhancement and causing only limited pressure drop can be obtained by blocking-ribs extending successively along at least three cross-contact-points along a zig-zag-path.

A further improvement with regard to pressure loss and heat transfer can be obtained by providing a first blocking-rib extending from the first cross-contact-point to a second cross-contact-point and by providing a second blocking-rib extending from a third contact point to a fourths cross-contact-point wherein the first blocking-rib and the second blocking-rib are inclined to each other and wherein the second cross-contact-point and the third cross-contact-point are adjacent cross-contact-points. Here adjacent means that the according cross-contact-points are nearest to each other respectively that there is no other cross-contact-point being nearer to the respective cross-contact-point.

According to the invention a significant impact on the secondary air consumption can be obtained by providing said blocking-ribs, first blocking-ribs or second blocking-ribs next to each other without directly contacting each other in a repeating pattern.

The invention also relates to a blade or a vane comprising an airfoil of the above disclosed type. Further the invention relates to a gas turbine comprising a blade or a vane of such type.

### BRIEF DESCRIPTION OF THE DRAWINGS

The above mentioned attributes and other features and advantages of this invention and the manner of attaining them will become more apparent and the invention itself will be better understood by referenced to the following description of the currently best mode of carrying out the invention taken in conjunction with the accompanying drawings, wherein

FIG. 1 shows a gas turbine blade (resp. gas turbine vane) schematically and partly sectioned showing the inside of an airfoil comprising a schematically depicted structure of ribs,

FIG. 2 showing a first embodiment schematically as a detail of FIG. 1 according to detail II in FIG. 1,

FIGS. 3, 4 respectively showing further embodiments according to the invention of said rib matrix structure,

FIG. 5 shows in cross-section V of FIG. 1 a profile of the airfoil.

### DETAILED DESCRIPTION OF INVENTION

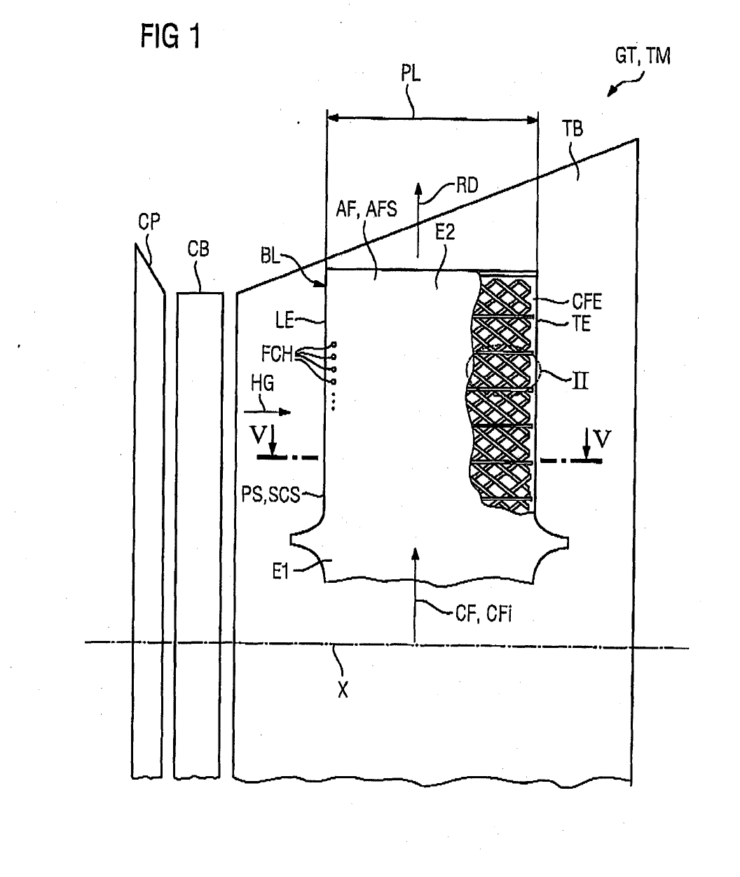

FIG. 1 shows an airfoil AF according to the invention schematically.

Further FIG. 1 shows—simplified—a turbo machine TM, respectively a gas turbine GT comprising a compressor CP a combustor CB and a turbine TB, all of which are schematically indicated in FIG. 1. Also indicated is a rotor axis X extending perpendicular to a radial direction RD, which coincides with a lengthwise direction of said airfoil AF. The airfoil AF of a blade BL for said turbo machine TM respectively said gas turbine GT comprises a leading edge LE and a trailing edge TE, wherein the leading edge is the most upstream part of the airfoil AF with regard to a stream of hot gas HG generated by said combustor CB and flowing along the airfoils surface AFS. The airfoil AF extends from a first end E1 to a second end E2 and a cooling fluid CF enters an inner cavity of the airfoil AF through a cooling fluid inlet CFI at said first end E1. While a part of the cooling fluid CF is ejected into the hot gas HG through film cooling holes FCH provided on the airfoils surface AFS another portion is led along several conducts through the airfoil AF until it is ejected through cooling fluid discharge exits CFE distributed along the trailing edge TE. With regard to the basically axial flow (according to rotor axis X) of the hot gas HG the airfoil AF of the blade BL is inclined by a rotation along the radial direction RD and therefore defining a more towards the flow of hot gas HG turned pressure-side and a less towards the flow of hot gas HG turned suction-side SCS, wherein both sides are defined from each other by said leading edge LE and said trailing edge TE. FIG. 1 and the other figures don't distinguish between said suction-side SCS and said pressure-side PS since both sides are interchangeable in theses depictions without altering the information from these figures—therefore said suction-side SCS and said pressure-side PS are referenced alternatively—if applicable.

FIG. 5 shows a cross-section V of FIG. 1. A profile of said airfoil AF illustrates said suction-side SCS and said pressure-side PS, said leading edge LE and said trailing edge TE with said profile length PL.

Said suction-side SCS and pressure-side PS of said airfoil AF are both established by a respective airfoil wall defining an outer surface AFS of said airfoil AF and an inner surface ISF of said airfoil AF, respectively a pressure-side inner surface PSF and a suction-side inner surface SSF. Said pressure-side inner surface PSF and sais suction-side inner surface SSF are respectively provided with inclined ribs, which are inclined to said radial direction RD, wherein said ribs on said suction-side inner surface SSF and said pressure-side inner surface PSF respectively from a plurality of cross-contact-points CCP distributed in a patent of a 2-dimensional matrix, which extends at least 10% along the profile length of the airfoil AF beginning from the trailing edge TE. Said profiles length PL is the distance between the leading edge LE and the trailing edge TE. Said cross-contact-points CCP, the ribs R of the pressure-side PS and the suction-side SCS contact each other and are preferably fixedly connected to each other to enhanced mechanical robustness. Only fluid following the inclination of said ribs RB along the inner surface of the pressure-side PSF or the inner surface of the suction-side SSF might follow a laminar path of low turbulence.

To increase turbulence enhancing heat transfer from said inner surfaces of pressure-side PS and suction-side SCS according to the invention blocking-ribs BR are provided extending from said pressure-side PS to said suction-side SCS and extending from one cross-contact-point CCP to another cross-contact-point CCP. In the context of said blocking-ribs BR a person with ordinary skill in the art understands that said blocking-ribs RB are solid flow guiding elements extending the whole way from said pressure-side inner surface PSF to said suction-side inner surface SSF in an area spreading at least from one cross-contact-point CCP to another contact point CCP and therefore forcing cooling fluid CF following said inclination angle of said ribs R to flow around said blocking ribs RB and therefore forcing also a change from the pressure-side PS to said suction-side SCS or vice versa.

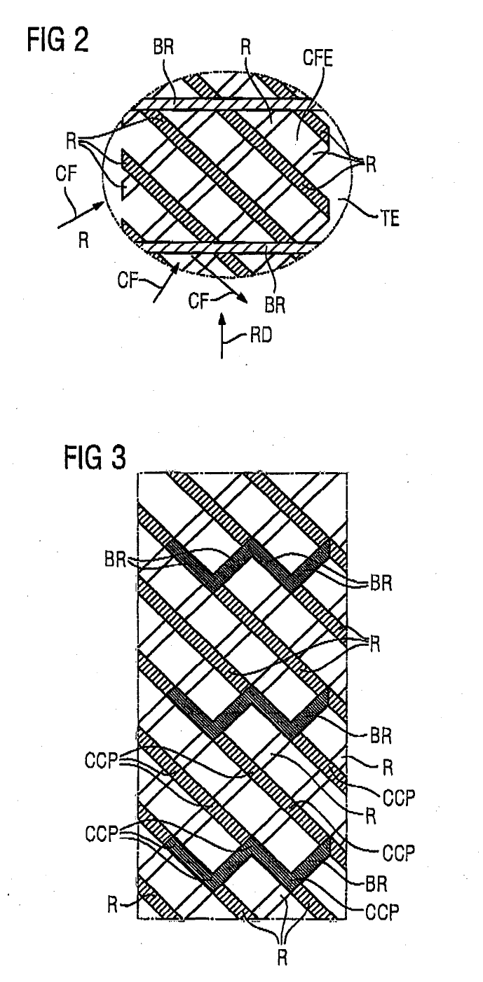

FIG. 1 shows a flat main surface of said blocking-ribs RB basically extending in a direction perpendicular to said radial direction RD and therefore inclined to the direction of said pressure-side PS and said suction-side SCS ribs R. This is shown in closer detail in FIG. 2 referring to a specifically indicated location of FIG. 1.

Another embodiment of said blocking-ribs BR is shown in FIG. 3, wherein blocking-ribs extend along a path defined by several adjacent cross-contact-points CCP in a zig-zag manner.

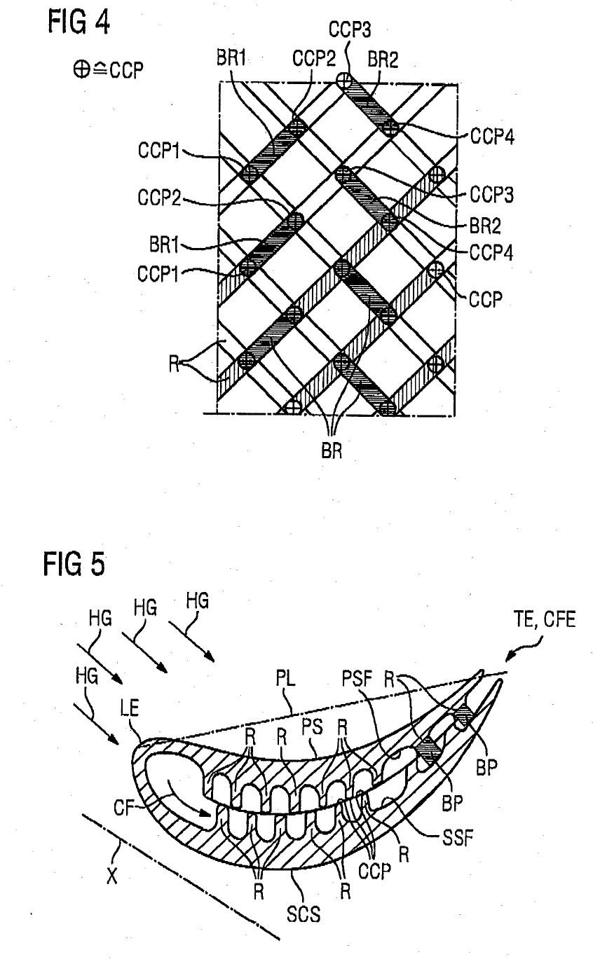

FIG. 4 shows a further preferred embodiment enhancing significantly the heat transfer, wherein a first blocking-rib BR1 extends from a first cross-contact-point CCP1 to a second cross-contact-point CCP2 and a second blocking-rib BR2 extends from a third cross-contact-point CCP3 to a fourth cross-contact-point CCP4, wherein said first blocking-rib BR1 and said second blocking-rib BR2 are inclined to each other and wherein said second cross-contact-point CCP2 and said third cross-contact-point CCP3 are adjacent cross-contact-points CCP.

1. An airfoil of a blade or a vane for a turbo machine, comprising:
cooling passages inside said airfoil, wherein said airfoil extends in a radial direction from a first end to a second end,
a cooling fluid inlet at said first end or said second end, wherein each radial cross section of said airfoil has a shape of a specific profile, wherein said airfoil is made to be exposed to a hot gas flowing along said airfoil's surface from a leading edge to a trailing edge of said profile,
wherein said airfoil's surface comprises a pressure-side and a suction-side which are defined from each other by said trailing edge and said leading edge, wherein said trailing edge is provided with cooling fluid discharge exits, wherein said pressure-side and said suction-side are respectively defined by a wall comprising an inner surface and an outer surface, which inner surface is provided with ribs extending in a rib-direction inclined to said radial direction, wherein along a portion of at least 10% of said profile's lengths said inclined ribs of said inner surface of said pressure-side and said suction-side contact each other at respective cross-contact-points, wherein said cross-contact-points form a 2-dimensional matrix, and
at least one additional blocking-rib extending from said pressure-side to said suction-side and extending from one cross-contact-point to another cross-contact-point to cause additional turbulence of said cooling fluid flow to be discharged.

2. The airfoil according to claim 1,
wherein said blocking-rib extends from one cross-contact-point to an adjacent cross-contact-point.

3. The airfoil according to claim 1,
wherein said blocking-rib extends in said radial direction.

4. The airfoil according to claim 1,
wherein said blocking-rib extends perpendicular to said radial direction.

5. The airfoil according to claim 4,
wherein said blocking-rib extends straight along at least three adjacent cross-contact-points.

6. The airfoil according to claim 2,
wherein said blocking-rib extends successively along at least three cross-contact-points along a zig-zag-path.

7. The airfoil according to claim 1,
wherein a first blocking-rib extends from a first cross-contact-point to a second cross-contact-point and a second blocking-rib extends from a third cross-contact-point to a fourth cross-contact-point,
wherein said first blocking-rib and said second blocking-rib are inclined to each other and
wherein said second cross-contact-point and said third cross-contact-point are adjacent cross-contact-points.

8. The airfoil according to claim 1,
wherein several of said blocking-ribs, first blocking-ribs and/or second blocking-ribs are provided next to each other without directly contacting each other in a repeating pattern along said 2-dimensional matrix.

9. A blade comprising a rotating blade of a gas turbine comprising an airfoil according to claim 1.

10. A vane of a gas turbine comprising an airfoil according to claim 1.

11. A gas turbine comprising at least one blade according to claim 9.

12. The airfoil of claim 1, wherein the turbo machine comprises a gas turbine.

13. A gas turbine comprising at least one vane according to claim 10.
